(19) United States
(12) Patent Application Publication
(10) Pub. No.: US 2011/0084971 A1
(43) Pub. Date: Apr. 14, 2011

(54) ADAPTIVE FRAME RATE MODULATION SYSTEM AND METHOD THEREOF

(75) Inventors: De-wei Kuo, Taipei City (TW); Jhen-Shen Liao, Bade City (TW); Yi-nan Chu, Tianwei Township (TW)

(73) Assignee: CHUNGHWA PICTURE TUBES, LTD., Bade City (TW)

(21) Appl. No.: 12/626,881

(22) Filed: Nov. 28, 2009

(30) Foreign Application Priority Data
Oct. 8, 2009 (TW) 098134163

(51) Int. Cl. G06T 1/00; G09G 5/10

(52) U.S. Cl. 345/501; 345/690

(57) ABSTRACT

An adaptive frame rate modulation system and method thereof are described. A frame processing unit is employed to receive a first frame and a second frame for dividing the second frame into a plurality of second block frames. A frame change detection unit compares the first block frames with the second block frames correspondingly for detecting the change status between the first and second frames. A timing generator classifies the second block frames of the second frame to construct a plurality of frame rates based on the compared results of the first and second block frames. The timing generator further modulates the frame rates of the second frames.

### FIELD OF THE INVENTION

The present invention relates to a modulation system and method thereof, and more particularly relates to an adaptive frame rate modulation system and method thereof.

### BACKGROUND OF THE INVENTION

With the rapid development of information technology (IT), more and more electronic products are produced and the quality of the products is not the unique option for the consumers. Green industry is more and more important which indicates the significance of energy saving and carbon reduction. Meanwhile, the electronic products' manufacturers continually provide the method of the power saving to reduce the power consumption. For an example of the display device, e.g. liquid crystal display (LCD), equipped with the electronic product, most of the power supplied to the electronic product is consumed by the LCD. Therefore, there is a need to reduce the power consumption of the LCD.

In one conventional case, the power consumption of the LCD is reduced by modulating the frame rate of the graphics card in the computer system. The frame rate of the graphics card is sixty frames per second (60 frames/sec), i.e. 60 Hz to be suitable for the acceptable sight frequency in view of human's eyes. However, when the frame is in a static display mode, it is not necessary to generate the higher frequency which is greater than 60 Hz of the frame rate. Therefore, a variety of frame rates would be stored in the graphics card to determine that the frame is in a static or dynamic display mode. When the frame of the graphics card is in the static display mode, the frame rate is decreased. When the frame of the graphics card is in the dynamic display mode, the frame rate is increased. The power saving is achieved while the frame rate is reduced. However, based on the change of frame rate in the graphics card, it is necessary to design an additional phase-locked loop (PLL) circuit for modifying the circuit layout of the graphics card, which results in the disadvantages of the complicated circuit design and increases the manufacturing cost of the graphics card.

In another conventional case, the control circuit determines that the frame is in a static or dynamic display mode for changing the scanning modes, including progressive type and interlaced type, of the gate driver in the display device. When the frame of the graphics card is in the dynamic display mode, the gate driver scans by progressive type, i.e. normal scan mode. When the frame of the graphics card is in the static display mode, the gate driver scans by interlaced type. For example, when the frame number “N” is displayed, the gate drivers in the odd lines are actuated, and when the frame number “N+1” is displayed, the gate drivers in the even lines are actuated. However, since the frequency is higher and static frame is displayed, human's eyes cannot identify the display defects on the display device. Thus, the operation frequency of the gate driver is reduced to one half and the power consumption is decreased accordingly. However, the disadvantages of the above-mentioned method is that it is necessary to detect the frame change by comparing two full frames and the scanning mode is interlaced type, resulting in frame display error when the frame is changed from static mode to dynamic mode and glittering on the frame. In addition, since the gate drivers are scanned by interlaced type, the selections of the frame rates are restricted. For example, the frame rate is 60 Hz or 30 Hz. Consequently, there is a need to improve the conventional frame rate modulation of the display system.

### SUMMARY OF THE INVENTION

First objective of the present invention is to provide an adaptive frame rate modulation system and method thereof to solve the problem of frame glitter.

Second objective of the present invention is to provide an adaptive frame rate modulation system and method thereof to solve the problem of frame display error.

Third objective of the present invention is to provide an adaptive frame rate modulation system and method thereof to construct a variety of power saving selections and save the cost of additional control circuits.

According to the above objectives, the present invention sets forth an adaptive frame rate modulation system and method thereof. The adaptive frame rate modulation system includes a frame processing unit, a counting unit, a frame change detection unit and a timing generator.

The frame processing unit sequentially receives a first frame and a second frame wherein the first frame has a plurality of first block frames and the frame processing unit divides the second frame into a plurality of second block frames. The frame change detection unit compares the first block frames and the second block frames correspondingly to detect the change status between the first frame and the second frame. The timing generator classifies the second block frames of the second frame to construct a plurality of frame rates based on the compared results of the first block frames and the second block frames. The timing generator further modulates the frame rates of the second frames in order to output the modulated frame rates associated with the second frames into the display device for displaying the second frames thereon. The counting unit is utilized to count the second frame to define the size of each of the second block frames. In one case, the first frame is a previous frame of the display device and the second frame is a current desired frame of the display device.

When the frame change detection unit detects that the brightness differences of the second block frames of the block sets are greater than a predetermined value, the timing generator maintains the frame rates of the block sets in a constant status. When the frame change detection unit detects that the brightness differences of the second block frames of the block sets are smaller than a predetermined value, the timing generator decreases the frame rates of the block sets. When the frame rates of two adjacent block sets are different and the second block frames of the two adjacent block sets are in a change status in relation to the first block frames, the timing generator selects the higher one of the frame rates of the block sets.

The adaptive frame rate modulation method includes the steps of:

(a) The frame processing unit sequentially receives a first frame and a second frame wherein the first frame has a plurality of first block frames.

(b) The frame processing unit divides the second frame into a plurality of second block frames.

(c) The data calculation module of the frame processing unit computes a first brightness value of each of the first block frames and a second brightness value of each of the second block frames. The frame change detection unit of the frame processing unit computes a brightness difference between the first brightness values of the first block frames and the second brightness values of the second block frames correspondingly and compares the brightness difference with a brightness threshold to determine the change status between the first frame and the second frame.

(d) The frame change detection unit compares the first block frames and the second block frames correspondingly for detecting the change status between the first frame and the second frame.

(e) The timing generator classifies the second block frames of the second frame for constructing a plurality of frame rates based on the compared results of the first block frames and the second block frames.

(f) The timing generator modulates the frame rates of the second frames for outputting the modulated frame rates associated with the second frames into the display device to display the second frames thereon.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of an adaptive frame rate modulation system according to one embodiment of the present invention;

FIG. 2 is a schematic view of a frame division according to one embodiment of the present invention;

FIG. 3A is a schematic view of dividing the first frame according to one embodiment of the present invention;

FIG. 3B is a schematic view of dividing the second frame according to one embodiment of the present invention;

FIG. 4 is a schematic view of outputting the control signals into the display device by the timing generator according to one embodiment of the present invention;

FIG. 5 is a schematic timing waveform of data enable signal, a plurality of output enable signals, and data signals according to one embodiment of the present invention; and

FIG. 6 is a flow chart of adaptive frame rate modulation method according to one embodiment of the present invention.

### DETAILED DESCRIPTION OF THE PREFERRED EMBODIMENTS

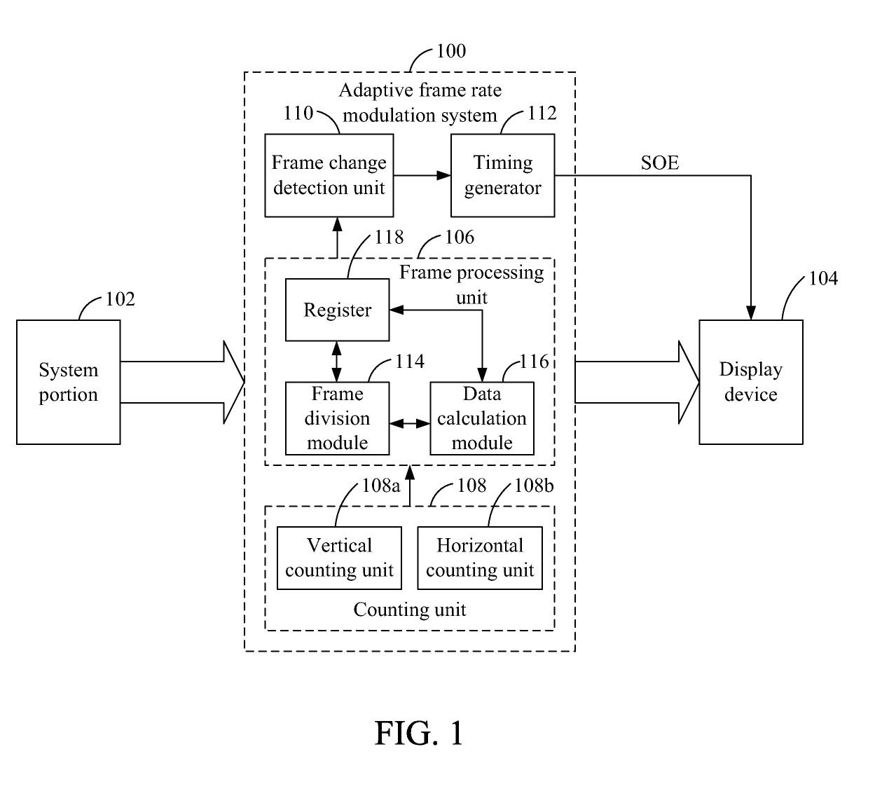

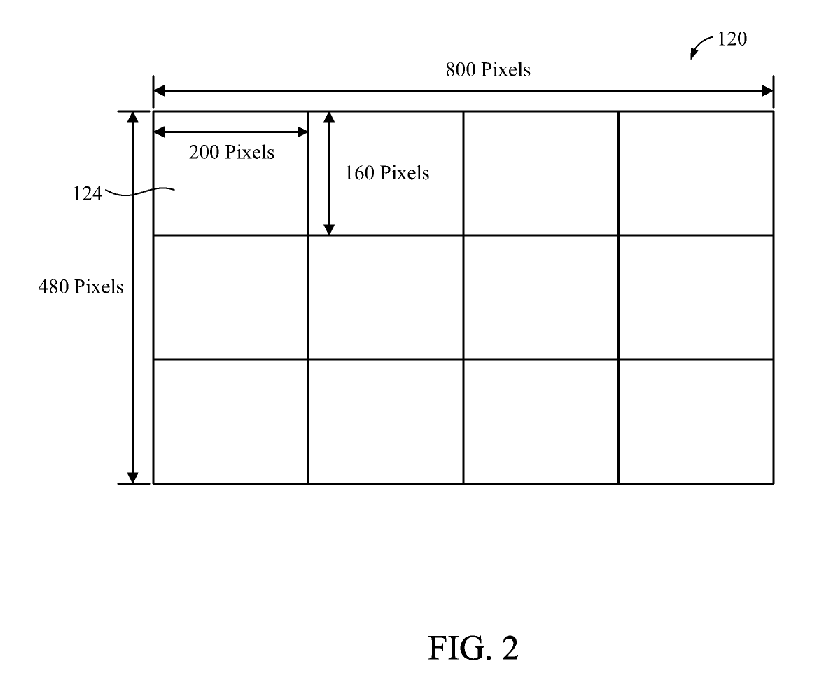

FIG. 1 is a schematic block diagram of an adaptive frame rate modulation system 100 according to one embodiment of the present invention. The adaptive frame rate modulation system 100 is applicable to display system, e.g. liquid crystal displays (LCDs). The adaptive frame rate modulation system 100 connects the system portion 102 to the display device 104. The system portion 102 serves as a video signal source. The display device 104 is used to display the frames generated from the adaptive frame rate modulation system 100. The adaptive frame rate modulation system 100 includes a frame processing unit 106, a counting unit 108, a frame change detection unit 110 and a timing generator 112. The frame processing unit 106, the counting unit 108, the frame change detection unit 110 and the timing generator 112 are coupled to the system portion 102 respectively for receiving the video source wherein the video source includes the frame data and the data enable signal (SDE). The system portion 102 employs the data enable signal (SDE) for enabling the adaptive frame rate modulation system 100 to output the frames 120 (as shown in FIG. 2) to the adaptive frame rate modulation system 100. The frame processing unit 106 couples the counting unit 108 to the frame change detection unit 110 and the timing generator 112 is coupled to the frame change detection unit 110.

In the adaptive frame rate modulation system 100, the frame processing unit sequentially receives a first frame and a second frame wherein the first frame has a plurality of first block frames and the frame processing unit 106 divides the second frame into a plurality of second block frames. The frame change detection unit 110 compares the first block frames and the second block frames correspondingly to detect the change status between the first frame and the second frame. The timing generator 112 classifies the second block frames of the second frame to construct a plurality of frame rates based on the compared results of the first block frames and the second block frames. The timing generator 112 further modulates the frame rates of the second frames in order to output the modulated frame rates associated with the second frames into the display device 104 for displaying the second frames thereon. The counting unit 108 is utilized to count the second frame to define the size of each of the second block frames. In one case, the first frame is a previous frame of the display device 104 and the second frame is a current desired frame of the display device 104.

Please refer to FIG. 1 and FIG. 2. FIG. 2 is a schematic view of a frame division 120 having a plurality of block frames 124 according to one embodiment of the present invention. The frame processing unit 106 divides the frame 120 into a plurality of block frames 124. Each of the block frames 124 has a plurality of pixels and each of the pixels is composed of three primary colors including red color (R), green color (G) and blue color (B). That is, each of the pixels has value R, value G and value B. In the present invention, a brightness value Y of each pixel can be generated by a conversion formula associated with the value R, value G and value B. For example, the conversion formula is represented by the following equation: Y=0.3*R+0.59*G+0.11*B. The frame processing unit 106 further calculates the sum of the brightness values Y of the pixels in each of the block frames.

In one embodiment, the frame processing unit 106 divides the frame 120 into twelve block frames 124, as shown in FIG. 2. The resolution of the frame 120 is 800*480 pixels and the resolution of each of the block frames 124 is 200*160 pixels wherein each pixel is composed of 6 bits in form of digital signal. When value R, value G and value B are 100, respectively, the brightness value Y is represented by the following equation: Y=0.3*100+0.59*100+0.11*100=100. Thus, each of the pixels has a brightness value by above computation. It should be noted that different conversion formula can be used to calculate the brightness value of each block frame.

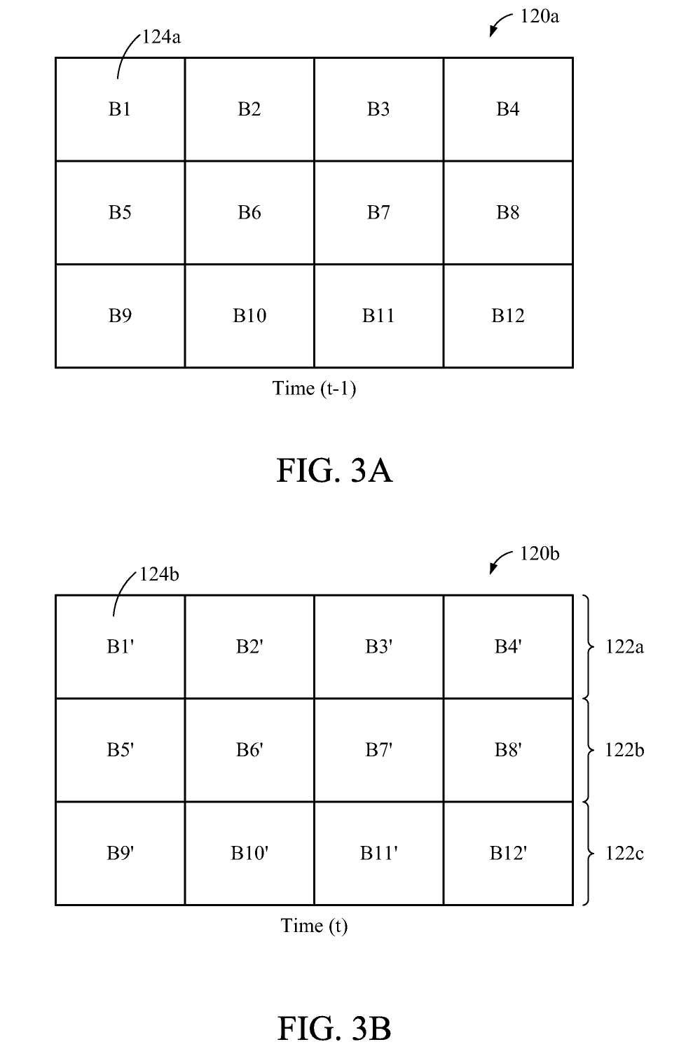

Please refer to FIG. 1 and FIGS. 3A-3B. FIG. 3A is a schematic view of dividing the first frame 120a according to one embodiment of the present invention. FIG. 3B is a schematic view of dividing the second frame 120b according to one embodiment of the present invention. The frame processing unit 106 further includes a frame division module 114, a data calculation module 116 and a register 118. The frame division module 114 is coupled to the data calculation module 116 and the register 118, respectively. The data calculation module 116 is coupled to the register 118. The frame division module 114 divides the first frame 120a into the first block frames 124a and divides the second frame 120b into the second block frames 124b. The data calculation module 116 computes a first brightness value of each of the first block frames 124a and a second brightness value of each of the second block frames 124b. The register 118 is used to store the first brightness values of the first block frames 124a and the second brightness values of the second block frames 124b. The counting unit further includes a horizontal counting unit 108a and a vertical counting unit 108b. The horizontal counting unit 108a counts a second horizontal counting value of each of the second block frames 124b for calculating the pixels along horizontal direction of the frames which are outputted from the system portion 102 to the adaptive frame rate modulation system 100. The vertical counting unit 108b counts a second vertical counting value of each of the second block frames 124b for calculating the pixels along vertical direction of the frames which are outputted from the system portion 102 to the adaptive frame rate modulation system 100. Therefore, the horizontal and vertical counting values can be used to define the size of each second block frame 124b.

As shown in FIG. 3A, the frame division module 114 divides the first frame 120a into the first block frames (B1 through B12) 124a at the previous time (t−1). As shown in FIG. 3A, the frame division module 114 divides the second frame 120b into the second block frames (B1′ through B12′) 124b at the current time (t). The data calculation module 116 computes a first brightness value of each of the first block frames (B1 through B12) 124a and a second brightness value of each of the second block frames (B1′ through B12′) 124b. The register 118 is used to store the first brightness values of the first block frames (B1 through B12) 124a and the second brightness values of the second block frames (B1′ through B12′) 124b.

The frame change detection unit 110 computes a brightness difference between the first brightness values of the first block frames (B1 through B12) and the second brightness values of the second block frames (B1′ through B12′) correspondingly and compares the brightness difference with a brightness threshold to determine the change status between the first frame 120a and the second frame 120b. The second block frames 124b are in a change status in relation to the first block frames 124a when the brightness difference is greater than the brightness threshold. The second block frames 124b are the same as the first block frames 124a when the brightness difference is smaller than the brightness threshold. In other words, the second block frames 124b are not in a change status in relation to the first block frames 124a when the brightness difference is greater than the brightness threshold.

The second frame 120b includes a plurality of block sets (122a, 122b, 122c), each of the block sets (122a, 122b, 122c) has a portion of second block frames (B1′ through B12′), and the block sets (122a, 122b, 122c) correspond to the frame rates respectively. When the frame change detection unit 110 detects that the brightness differences of the second block frames (B1′ through B12′) of the block sets (122a, 122b, 122c) are greater than a predetermined value, the timing generator 112 maintains the frame rates of the block sets (122a, 122b, 122c) in a constant status. When the frame change detection unit 110 detects that the brightness differences of the second block frames (B1′ through B12′) of the block sets (122a, 122b, 122c) are smaller than a predetermined value, the timing generator 112 decreases the frame rates of the block sets (122a, 122b, 122c).

In one embodiment, after the first block frame 124a of the first frame 120a is compared with the second block frame 124b of the second frame 120b, the second frame 120n is divided into three block sets (122a, 122b, 122c) including the first block set (B1′ through B4′), the second block set (B5′ through B8′) and the third block set (B9′ through B12′). In view of each block sets (122a, 122b, 122c), the frame change detection unit 110 calculates the amount of the second block frames 124b with change status to determine whether the frame rates of the block sets (122a, 122b, 122c) are adjusted for starting the power saving mechanism. For example, the first block set (B1′ through B4′) includes four block frames 124b. If more than two block frames are changed, i.e. the predetermined value is equal to two, the frame rate of the first block set (B1′ through B4′) 122a is kept in 60 Hz. If less than two block frames are changed, the frame rate of the first block set (B1′ through B4′) 122a is modulated to be 50 Hz. If no block frame is changed, i.e. static frame, the frame rate of the first block set (B1′ through B4′) 122a is modulated to be 40 Hz. Similarly, the determination and modulation associated with the second block set (B5′ through B8′) 122b and the third block set (B9′ through B12′) 122c are the same as these of the first block set (B1′ through B4′) 122a.

In the present invention, when the frame rates of two adjacent block sets (122a, 122b, 122c) are different and the second block frames (B1′ through B12′) of the two adjacent block sets (122a, 122b, 122c) are in a change status in relation to the first block frames 124a, the timing generator 112 selects the higher one of the frame rates of the block sets (122a, 122b, 122c). In other words, when the changed frames are located in the frame boundary between the first block set 122a, the second block set 122b and the third block set 122c and the frame rates of two adjacent block sets (122a, 122b, 122c) are different, the adaptive frame rate modulation system 100 further avoids the frame display error in the frame boundary by detecting whether two adjacent block frames 124b of upper and lower block sets (122a, 122b, 122c) has a change status. Specifically, when two adjacent block frames 124b of upper and lower block sets (122a, 122b, 122c) has a change status and the frame rates of two adjacent block sets (122a, 122b, 122c) are different, the timing generator 112 designates two adjacent block sets (122a, 122b, 122c) to be in the higher one of the frame rates of the block sets (122a, 122b, 122c) to solve the problem of frame display error.

While performing the frame rate modulation of LCD, the adaptive frame rate modulation system 100 utilizes the output enable signal for controlling the on/off status of the gate driver in the display device 104. In one embodiment, when the output enable signal is in a high level, the timing generator 112 turns off the thin film transistor (TFT) of the gate driver. When the output enable signal is in a low level, the timing generator 112 turns on the thin film transistor (TFT) of the gate driver. Thus, the adaptive frame rate modulation system 100 is capable of determining whether the frame data of the second block frame of the block sets are updated for adaptively modulating the frame rate. The modulation of the adaptive frame rate modulation system 100 is described in detailed below.

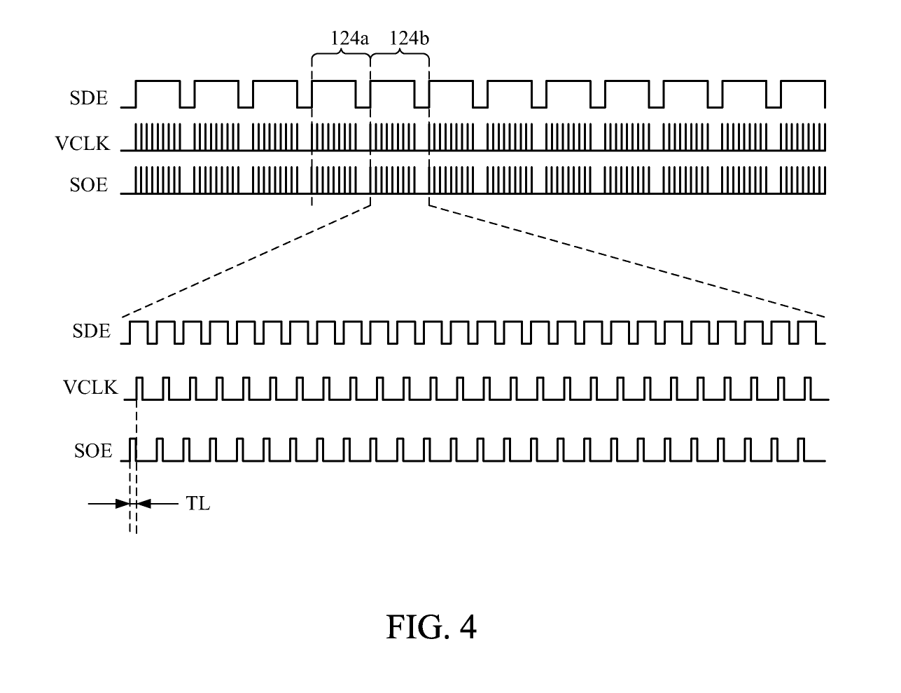

Please refer to FIG. 1, FIGS. 3A-3B and FIG. 4. FIG. 4 is a schematic view of outputting the data enable signal (SDE) and control signals into the display device 104 by the timing generator 112 according to one embodiment of the present invention. The control signal includes a vertical clock signal (VCLK) and an output enable signal (SOE). In view of a frame, the vertical clock signal (VCLK) corresponds to the vertical scan lines of the second frame 120b. That is, the amount of the vertical scan lines is equal to the vertical counting value of the second frame 120b. The timing generator 112 enables the display device 104 based on the level of the output enable signal (SOE) to allow the adaptive frame rate modulation system 100 to selectively output the frame data of the block sets of the second frame 120b into the display device 104. For example, the output enable signal (SOE) is output enable voltage. In one preferred embodiment, the output enable signal (SOE) is triggered before the rising edge of the vertical clock signal (VCLK) is generated, represented by duration “TL” shown in FIG. 4, for correctly controlling the output of the frame data of the block sets of the second frame 120b.

Therefore, the adaptive frame rate modulation system 100 uses the frame processing unit 106 for dividing the second frame 120b into a plurality of block frames 124b and modulates the frame rate of the block sets (122a, 122b, 122c) based on the change status of the block frames to solve the problem of frame glitter of the second frame 120b.

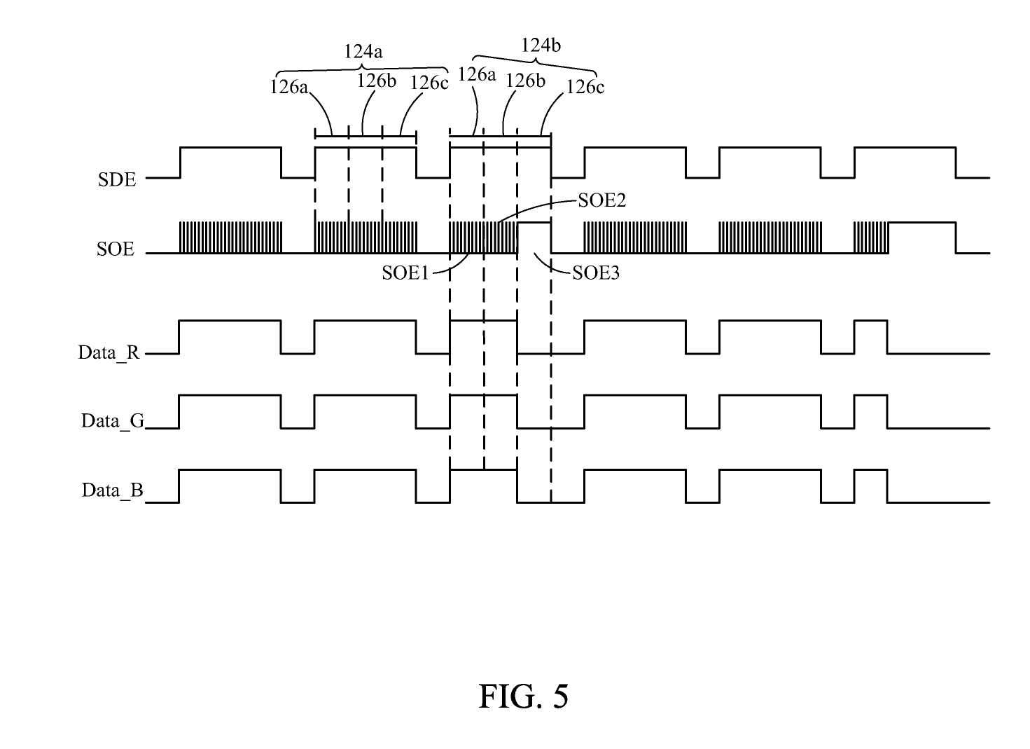

Please refer to FIG. 1, FIGS. 3A-3B, and FIG. 5. FIG. 5 is a schematic timing waveform of data enable signal (SDE), a plurality of output enable signals (SOE), and data signals according to one embodiment of the present invention. In one embodiment, the high level of the data enable signal (SDE) is divided into three portions (126a, 126b, 126c) which correspond to the first block set 122a, second block 122b and third block set 122c of the second block frame 120b, respectively. The output enable signal (SOE) has three potions including a first output enable signal (SOE1), a second output enable signal (SOE2) and a third output enable signal (SOE3) which correspond to the three portions (126a, 126b, 126c) of the data enable signal (SDE). The pixels of the block sets (122a, 122b, 122c) of the second frame 120b are composed of frame data “Data_R”, “Data_G”, and “Data_B”.

In the adaptive frame rate modulation system 100, each of the frame rates corresponds to each of the block sets (122a, 122b, 122c). While the timing generator 112 modulates (e.g. either increases or decreases) the frame rates of the block sets (122a, 122b, 122c), the timing generator 112 selectively enables the display device 104 based on the modulated frame rate for outputting the block sets (122a, 122b, 122c) of the second frame 120b into the display device 104. When the timing generator 112 maintains the frame rate of the block sets (122a, 122b, 122c) in a constant value, the timing generator 112 outputs the constant frame data of the block sets (122a, 122b, 122c) of the second frame 120b into the display device 104. Consequently, the output of the constant frame data can be used to prevent the additional power consumption due to frame data variation.

In comparison with the first frame 120a, the second frame 120b is in change status and its frame rate is 60 Hz, i.e. 60 frames per second. When the frame rate is reduced to 50 Hz, the frame rate of the second 120b is 50 frames per second, i.e. decrement of ten frames in view of 60 Hz. The rest is on the analogy of this matter. The adaptive frame rate modulation system 100 utilizes the timing generator 112 to transmit the output enable signal (SOE) for turning off the TFT of the pixel and stops to update the frame data. Thus, when the frame rate is down to 50 Hz, the output enable signal (SOE) of one frame in every six frames is in high level for turning off the TFTs in the frame. Therefore, the frame data of ten frames in 60 frames per second are not updated so as to modulate the frame rate of the block sets (122a, 122b, 122c) of the second frame 120b. When the frame rate is reduced to 40 Hz, the frame rate of the second 120b is 40 frames per second, i.e. decrement of twenty frames in view of 60 Hz. Thus, when the frame rate is down to 40 Hz, the output enable signal (SOE) of one frame in every three frames is in high level for turning off the TFTs of the frame.

In one embodiment, the frame rates of the first block set 122a, second block set 122b and third block set 122c of the second frame 120b are 60 Hz, 50 Hz and 40 Hz, respectively. These frame rates is represented by the first output enable signal (SOE1), the second output enable signal (SOE2) and the third output enable signal (SOE3), as shown in FIG. 5. The frame rate in each of the block sets is different and the output enable signal (SOE) is transmitted to the display device 104 based on the different frame rate. When the output enable signal (SOE) is in high level, the TFT is turned off and the adaptive frame rate modulation system 100 maintains the frame data from the system portion 102 in a constant status. That is, the frame data is not updated when the TFT is not triggered. As shown in FIG. 5, the frame rates 60 Hz, 50 Hz and 40 Hz corresponding to frame data “Data_”, “Data_G” and “Data_B” respectively are used to selectively turn off the TFT I order to prevent the additional power consumption due to frame data update.

According to the above-mentioned descriptions, the adaptive frame rate modulation system 100 utilizes the timing generator 112 to construct a variety of power saving selections corresponding to the block sets of the second frame and save the cost of additional control circuits in the system portion 102.

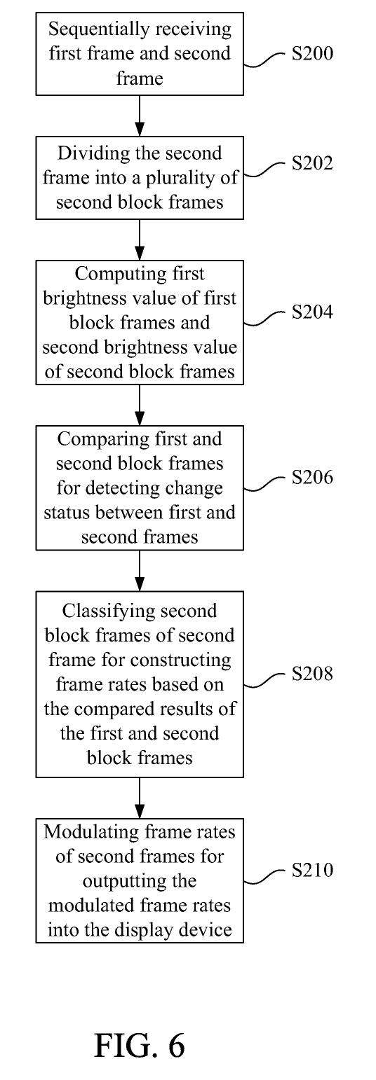

Please refer FIG. 1 and FIG. 6. FIG. 6 is a flow chart of adaptive frame rate modulation method according to one embodiment of the present invention. The adaptive frame rate modulation system 100 includes a frame processing unit 106, a counting unit 108, a frame change detection unit 110 and a timing generator 112. The adaptive frame rate modulation method includes the following steps of:

In step S200, the frame processing unit 106 sequentially receives a first frame and a second frame wherein the first frame has a plurality of first block frames. The frame processing unit 106 divides the first frame into a plurality of first block frames. In one embodiment, the counting unit 108 counts the second frame to define the size of each of the second block frames.

In step S202, the frame processing unit 106 divides the second frame into a plurality of second block frames.

In step S204, the data calculation module 116 of the frame processing unit 106 computes a first brightness value of each of the first block frames and a second brightness value of each of the second block frames. The frame change detection unit 110 of the frame processing unit 106 computes a brightness difference between the first brightness values of the first block frames and the second brightness values of the second block frames correspondingly and compares the brightness difference with a brightness threshold to determine the change status between the first frame and the second frame.

In step S206, the frame change detection unit 110 compares the first block frames and the second block frames correspondingly for detecting the change status between the first frame and the second frame.

In step S208, the timing generator 112 classifies the second block frames of the second frame for constructing a plurality of frame rates based on the compared results of the first block frames and the second block frames. The second block frames are in a change status in relation to the first block frames when the brightness difference is greater than the brightness threshold. The second block frames are the same as the first block frames when the brightness difference is smaller than the brightness threshold. The second frame includes a plurality of block sets, each of the block sets has a portion of second block frames, and the block sets correspond to the frame rates respectively.

In step S210, the timing generator 112 modulates the frame rates of the second frames for outputting the modulated frame rates associated with the second frames into the display device 104 to display the second frames thereon. When the frame change detection unit 110 detects that the brightness differences of the second block frames of the block sets are greater than a predetermined, the timing generator 112 maintains the frame rates of the block sets in a constant status. When the frame change detection unit 110 detects that the brightness differences of the second block frames of the block sets are smaller than a predetermined value, the timing generator 112 decreases the frame rates of the block sets. When the frame rates of two adjacent block sets are different and the second block frames of the two adjacent block sets are in a change status in relation to the first block frames, the timing generator 112 selects the higher one of the frame rates of the block sets. In the adaptive frame rate modulation method, each of the block sets corresponds to each of the frame rates respectively. After the timing generator 112 modulates the frame rates of the block sets, the timing generator 112 selectively enables the display device 104 based on the modulated frame rates for outputting the block sets of the second frame into the display device 104. When the timing generator 112 maintains the frame rates of the block sets in a constant status, the timing generator 112 outputs the block sets of the second frame which have constant frame data into the display device 104. Consequently, the output of the constant frame data can be used to prevent the additional power consumption due to frame data variation.

According to the above-mentioned descriptions, the adaptive frame rate modulation system uses the frame processing unit for dividing the second frame into a plurality of block frames and modulates the frame rate of the block sets based on the change status of the block frames to solve the problem of frame glitter of the second frame. When the changed frames are located in the frame boundary between the first block set, the second block set and the third block set and the frame rates of two adjacent block sets are different, the adaptive frame rate modulation system further avoids the frame display error in the frame boundary by detecting whether two adjacent block frames of upper and lower block sets has a change status. Additionally, the adaptive frame rate modulation system utilizes the timing generator to construct a variety of power saving selections corresponding to the block sets of the second frame and save the cost of additional control circuits in the system portion.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An adaptive frame rate modulation system which is suitable for a display device, the adaptive frame rate modulation system comprising:
a frame processing unit, for sequentially receiving a first frame and a second frame, wherein the first frame has a plurality of first block frames and the frame processing unit divides the second frame into a plurality of second block frames;
a frame change detection unit coupled to the frame processing unit, for comparing the first block frames and the second block frames correspondingly to detect the change status between the first frame and the second frame; and
a timing generator coupled to the frame-change detection unit, for classifying the second block frames of the second frame to construct a plurality of frame rates based on the compared results of the first block frames and the second block frames, and for modulating the frame rates of the second frames in order to output the modulated frame rates associated with the second frames into the display device for displaying the second frames thereon.

2. The adaptive frame rate modulation system of claim 1, wherein the frame processing unit further comprises:
a frame division module, for dividing the first frame into the first block frames and dividing the second frame into the second block frames;
a data calculation module coupled to the frame division module, for computing a first brightness value of each of the first block frames and a second brightness value of each of the second block frames; and
a register coupled to the frame division module and the data calculation module, for storing the first brightness values of the first block frames and the second brightness values of the second block frames.

3. The adaptive frame rate modulation system of claim 2, wherein the frame change detection unit computes a brightness difference between the first brightness values of the first block frames and the second brightness values of the second block frames correspondingly and compares the brightness difference with a brightness threshold to determine the change status between the first frame and the second frame.

4. The adaptive frame rate modulation system of claim 3, wherein the second block frames are in a change status in relation to the first block frames when the brightness difference is greater than the brightness threshold.

5. The adaptive frame rate modulation system of claim 3, wherein the second block frames are the same as the first block frames when the brightness difference is smaller than the brightness threshold.

6. The adaptive frame rate modulation system of claim 3, wherein the second frame comprises a plurality of block sets, each of the block sets has a portion of second block frames, and the block sets correspond to the frame rates respectively.

7. The adaptive frame rate modulation system of claim 6, wherein when the frame change detection unit detects that the brightness differences of the second block frames of the block sets are greater than a predetermined value, the timing generator maintains the frame rates of the block sets in a constant status.

8. The adaptive frame rate modulation system of claim 6, wherein when the frame change detection unit detects that the brightness differences of the second block frames of the block sets are smaller than a predetermined value, the timing generator decreases the frame rates of the block sets.

9. The adaptive frame rate modulation system of claim 6, wherein when the frame rates of two adjacent block sets are different and the second block frames of the two adjacent block sets are in a change status in relation to the first block frames, the timing generator selects the higher one of the frame rates of the block sets.

10. The adaptive frame rate modulation system of claim 6, wherein each of the block sets corresponds to each of the frame rates respectively and after the timing generator modulates the frame rates of the block sets, the timing generator selectively enables the display device based on the modulated frame rates for outputting the block sets of the second frame into the display device.

11. The adaptive frame rate modulation system of claim 10, wherein when the timing generator maintains the frame rates of the block sets in a constant status, the timing generator outputs the block sets of the second frame which have constant frame data into the display device.

12. The adaptive frame rate modulation system of claim 1, further comprising a counting unit coupled to the frame processing unit, for counting the second frame to define the size of each of the second block frames.

13. The adaptive frame rate modulation system of claim 12, wherein the counting unit further comprises:
a horizontal counting unit, for counting a second horizontal counting value of each of the second block frames; and
a vertical counting unit, for counting a second vertical counting value of each of the second block frames.

14. An adaptive frame rate modulation method which is suitable for a display device, the method comprising the steps of:
(a) sequentially receiving a first frame and a second frame by a frame processing unit, wherein the first frame has a plurality of first block frames;
(b) dividing the second frame into a plurality of second block frames by the frame processing unit;
(c) comparing the first block frames and the second block frames correspondingly by a frame change detection unit for detecting the change status between the first frame and the second frame;
(d) classifying the second block frames of the second frame by a timing generator for constructing a plurality of frame rates based on the compared results of the first block frames and the second block frames; and
(e) modulating the frame rates of the second frames for outputting the modulated frame rates associated with the second frames into the display device to display the second frames thereon.

15. The adaptive frame rate modulation method of claim 14, during the step (a), further comprising a step of dividing the first frame into the first block frames by the frame processing unit.

16. The adaptive frame rate modulation method of claim 15, after the step (b), further comprising a step (b1): computing a first brightness value of each of the first block frames and a second brightness value of each of the second block frames by the frame processing unit.

17. The adaptive frame rate modulation method of claim 16, during the step (b1), further comprising a step of computing a brightness difference between the first brightness values of the first block frames and the second brightness values of the second block frames correspondingly.

18. The adaptive frame rate modulation method of claim 17, during the step (b1), further comprising a step of comparing the brightness difference with a brightness threshold to determine the change status between the first frame and the second frame.

19. The adaptive frame rate modulation method of claim 18, wherein during the step (d), the second block frames are in a change status in relation to the first block frames when the brightness difference is greater than the brightness threshold.

20. The adaptive frame rate modulation method of claim 18, wherein during the step (d), the second block frames are the same as the first block frames when the brightness difference is smaller than the brightness threshold.

21. The adaptive frame rate modulation method of claim 18, wherein during the step (d), the second frame comprises a plurality of block sets, each of the block sets has a portion of second block frames, and the block sets correspond to the frame rates respectively.

22. The adaptive frame rate modulation method of claim 21, wherein when the frame change detection unit detects that the brightness differences of the second block frames of the block sets are greater than a predetermined value during the step (e), the timing generator maintains the frame rates of the block sets in a constant status.

23. The adaptive frame rate modulation method of claim 21, wherein when the frame change detection unit detects that the brightness differences of the second block frames of the block sets are smaller than a predetermined value during the step (e), the timing generator decreases the frame rates of the block sets.

24. The adaptive frame rate modulation method of claim 21, wherein when the frame rates of two adjacent block sets are different and the second block frames of the two adjacent block sets are in a change status in relation to the first block frames during the step (e), the timing generator selects the higher one of the frame rates of the block sets.

25. The adaptive frame rate modulation method of claim 21, wherein each of the block sets corresponds to each of the frame rates respectively and after the timing generator modulates the frame rates of the block sets during the step (e), the timing generator selectively enables the display device based on the modulated frame rates for outputting the block sets of the second frame into the display device.

26. The adaptive frame rate modulation method of claim 21, wherein when the timing generator maintains the frame rates of the block sets in a constant status during the step (e), the timing generator outputs the block sets of the second frame which have constant frame data into the display device.

27. The adaptive frame rate modulation method of claim 14, during the step (e), further comprising a step of counting the second frame for defining the size of each of the second block frames.
